(19) United States
(12) Patent Application Publication
(10) Pub. No.: US 2004/0198317 A1
(43) Pub. Date: Oct. 7, 2004

(54) Terminal device having calling function and method of making communication through the terminal device

(75) Inventor: Hiromichi Ishida, Shizuoka (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/832,323

(22) Filed: Apr. 27, 2004

Related U.S. Application Data
(62) Division of application No. 09/621,559, filed on Jul. 21, 2000.

(30) Foreign Application Priority Data
Jul. 21, 1999 (JP) 11-206461

(51) Int. Cl. H04M 15/00

(52) U.S. Cl. 455/407

(57) ABSTRACT

There is provided an information terminal having a function of making a call, including (a) a communicator making communication with a calling or called party, (b) a memory storing at least one an exception code, and (c) a main control unit. The main control unit determines an item to be monitored, judges whether the item meets with a predetermined condition for prohibiting making a call, judges whether a code of a calling or called party is coincident with the exception code, and prohibits making a call, if the predetermined condition is satisfied, and if the code of a calling or called party is not coincident with the exception code. The present invention suppresses an excess in a communication fee.

### BACKGROUND OF THE INVENTION

1. Field of the Invention

The invention relates to an information terminal having a calling function, a method of making communication by means of an information terminal, and a storage medium which stores a control program for controlling the information terminal, and more particularly to an information terminal having a caller account function, a method of suppressing an increase in a communication fee, and a storage medium which stores a control program for controlling the information terminal.

2. Description of the Related Art

Recently, information terminals, such as PHS and mobile phones, that have a function of transmitting messages, have spread explosive vigor. With these kinds of information terminals, due to convenience thereof, a frequency of communication and time length of communication have increased. Moreover, since a fee of use has been set higher than a fee for a normal telephone, a fee for using such information terminals often becomes very high.

Therefore, in order to prevent this kind of problem, for instance, Japanese Unexamined Patent Publication No. 9-200339 has suggested an information terminal equipped with a function for keeping a communication fee from becoming too high. This function for suppressing a communication fee is accomplished as follows, for instance.

Account information is sent to the information terminal from a base station of a mobile phone system. The information terminal uses the received account information to calculate a calling rate for dialed calls within a predetermined unit period. Then, the information terminal compares the thus calculated calling rate with a predetermined upper limit of a calling rate. When the result of comparison shows that the calculated calling rate exceeds the upper limit, outgoing calls within this period are prohibited.

Herein, the predetermined unit period means a unit period for evaluating whether a communication fee is high or low. The upper limit of a calling rate means a calling rate corresponding to an upper limit of a communication fee within the predetermined unit period. Moreover, a calling rate continues to be counted in a display in which a communication fee corresponding to a total calling rate is displayed, as long as a user does not intentionally reset the calculated calling rate.

Apart from the above-mentioned Publication, many attempts have been made to suppress a communication fee.

For instance, Japanese Unexamined Patent Publication No. 6-78079 has suggested a system for providing account information to a user. In the suggested system, a total number of callings and a total communication fee within a predetermined period is informed to a user each time of a call or when a user desired to know.

Japanese Unexamined Patent Publication No. 6-245255 has suggested a method of making communication through mobile terminals in a communication system including a mobile terminal having means for transmitting and receiving signals, a base station, and an exchange system having an exchanger and a computer. The mobile terminal, the base station and the exchange system are communicated with one another through a communication line. The exchanger carries out service of transmitting a call to and receiving a call from a subscriber.

The exchange system stores therein personal data including data as to whether the mobile terminal is allowed to transmit a call to and receive a call from a mobile terminal owned by a subscriber other than subscribers of the exchanger, and decides whether the mobile terminal is allowed to transmit a call to and receive a call from a mobile terminal owned by a subscriber other than subscribers of the exchanger, based on the personal data, when a request of transmitting a call or receiving a call is made through the exchanger from a mobile terminal owned by a subscriber other than subscribers of the exchanger.

Japanese Unexamined Patent Publication No. 7-327095 has suggested an apparatus for monthly calculating a calling fee in a telephone terminal managed by an in-house exchanger, in the case that communication lines which cannot be treated with call-by-call are used in a monthly fee system.

Japanese Patent Publication No. 8-2075 has suggested an apparatus for calculating a calling fee, including first means for storing account data transmitted from a controller of an exchanger, and reading out the account data in the form of a data block each time the account data is stored in a predetermined amount, second means for inputting an instruction by which the account data is to be read out, and third means for writing dummy data into the second means to store account data in the predetermined amount, when the instruction is input through the second means, and for reading out the data block of the account data.

Japanese Unexamined Patent Publication No. 11-69019 has suggested a system for managing a communication fee, including at least one parent telephone, at least one child telephone to be monitored by the parent telephone, and means for informing the parent telephone of a communication fee caused by communication of the child telephone.

However, the above-mentioned prior art are accompanied with the following problems.

The first problem is as follows.

The above-mentioned prior art was inconvenient in terms of flexibility. In addition, the above-mentioned prior art has a problem that it was not able to handle diverse service needs. In other words, in the prior art, when a total calling rate exceeds a predetermined upper limit, a calling function is entirely suppressed, and hence, it is not possible to make any calls within a predetermined period.

However, in actual use of an information terminal, there are cases when it is desired to make an outgoing call, even if an increase in a communication fee is ignored. For instance, when a call is to be made to an important client, or when an emergency call is to be made, a user does not pay regard to an increase in a communication fee.

However, in the above-mentioned prior art, since all outgoing calls are suppressed, it is not possible to meet with such needs as mentioned above.

In addition, since access to contract services such as discount communication services for particular users is also prohibited, the contract services are prevented from being increased.

The second problem is as follows.

In the above-mentioned prior art, a communication fee is inaccurately calculated, the thus inaccurately calculated fee is displayed, in some cases.

In order to accurately calculate a communication fee within a predetermined unit period, it is necessary to reset a calculated calling rate at the start of the predetermined unit period. In the prior art, a user carried out such resetting a calculated calling rate by performing a key operation. Accordingly, when a user forgot to reset a calling rate, a new calling rate for a predetermined unit period was added to a calculated calling rate in a previous predetermined unit period.

On the other hand, when a calling rate is reset before a predetermined unit period passes, a calling rate having been calculated so far in the predetermined unit period is not reflected in a total calling rate displayed in a display screen. As a result, a communication fee was displayed lower than an actual communication fee, in a display screen.

### SUMMARY OF THE INVENTION

In view of the above-mentioned problems in the prior art, it is an object of the present invention to provide an information terminal having a function for suppressing an excess in a communication fee.

It is also an object of the present invention to provide a method of suppressing an increase in a communication fee in communication through the use of an information terminal.

Another object of the present invention is to provide a storage medium for storing a control program for controlling an information device.

In one aspect of the present invention, there is provided an information terminal having a function of making a call, including (a) a communicator-making communication with a calling or called party, (b) a memory storing at least one an exception code, and (c) a main control unit, the main control unit (c1) determining an item to be monitored, (c2) judging whether the item meets with a predetermined condition for prohibiting making a call, (c3) judging whether a code of a calling or called party is coincident with the exception code, and (c4) prohibiting making a call, if the predetermined condition is satisfied, and if the code of a calling or called party is not coincident with the exception code.

It is preferable that the main control unit allows a desired exception code to be stored in the memory.

It is preferable that the main control unit judges whether a clear condition is satisfied or not, and reset the item, if the clear condition is satisfied.

It is preferable that the information terminal further includes a controller for designating the clear condition.

It is preferable that the main control unit determines a fee index corresponding to a communication fee, as the item, judges whether the fee index is over a predetermined upper limit of a fee index, and judges that the predetermined condition for prohibiting making a call is satisfied, if the fee index is over the predetermined upper limit of a fee index.

It is preferable that the main control unit calculates the fee index, based on an index signal transmitted during communication.

For instance, the clear condition may be that the present date reaches a predetermined date. As an alternative, the clear condition may be that a predetermined data is transmitted during communication.

There is further provided an information terminal having a function of making a call, including (a) a communicator making communication with a calling or called party, and (b) a main control unit, the main control unit (b1) calculates a fee index reflecting a fee of communication made by the communicator, (b2) integrates the communication fee to thereby calculate a total fee index, (b3) judges whether initialization condition is satisfied, and (b4) initializes the total fee index if the initialization condition is satisfied.

It is preferable that the main control unit includes at least one of a calendar device and a timer, and that the initialization condition is that the present date reaches a predetermined date.

It is preferable that the main control unit includes predetermined ID data, and that the initialization condition is that the communicator receives the ID data.

It is preferable that the main control unit has a function of setting or changing the ID data.

There is still further provided an information terminal having a function of making a call, the information terminal prohibiting making a call when a total communication fee is over a threshold upper limit, but allowing making a call to a party or parties having been set in advance as an exception or exceptions even when a total communication fee is over a threshold upper limit.

It is preferable that the total communication fee is automatically reset when a predetermined clear condition is satisfied.

In another aspect of the present invention, there is provided a method of making communication by means of an information terminal having a function of making a call, including the steps of (a) setting at least one exception code, (b) determining an item to be monitored, (c) judging whether the item meets with a predetermined condition for prohibiting making a call, (d) judging whether a code of a calling or called party is coincident with the exception code, and (e) prohibiting making a call, if the predetermined condition is satisfied, and if the code of a calling or called party is not coincident with the exception code.

It is preferable that the method further includes the steps of (f) judging whether a clear condition is satisfied or not, and (g) resetting the item, if the clear condition is satisfied.

It is preferable that the method further includes the step of determining a fee index corresponding to a communication fee, as the item.

It is preferable that the method further includes the steps of (h) judging whether the fee index is over a predetermined upper limit of a fee index, and (i) carrying out the step (c), if the fee index is over the predetermined upper limit of a fee index.

It is preferable that the method further includes the step of calculating the fee index, based on an index signal transmitted during communication.

There is further provided a method of making communication by means of an information terminal having a function of making a call, including the steps of (a) judging whether a total communication fee is over a threshold upper limit, and (b) prohibiting making a call when the total communication fee is over the threshold upper limit, and allowing making a call to a party or parties having been set in advance as an exception or exceptions even when the total communication fee is over the threshold upper limit.

It is preferable that the method further includes the step of resetting the total communication fee when a predetermined clear condition is satisfied.

In still another aspect of the present invention, there is provided a storage medium readable by a computer, storing a program therein for causing a computer to act as the above-mentioned information terminal having a function of making a call.

There is further provided a storage medium readable by a computer, storing a program therein for causing a computer to carry out the above-mentioned method of making communication by means of an information terminal having a function of making a call.

Hereinbelow is explained an operation of the above-mentioned present invention.

First, the function of the information terminal and the function of the storage medium containing a control program for controlling an operation of the information terminal are explained.

When the main control unit receives a destination code, the following process is performed. The main control unit determines an item to be monitored. For instance, there may be selected a fee index which is determined corresponding to a communication fee, as an item to be monitored. In the present invention, the fee index can be determined based on an index signal transmitted when communication is made.

Then, the item detected by the main control unit is judged whether it meets with suppression conditions. For example, when the main control unit determines a fee index, the suppression condition can be an upper limit of the fee index. In the present invention, it is judged whether the fee index detected by the main control unit exceeds the upper limit of the fee index. When the result of this judgment shows that the item exceeds the upper limit of the fee index, it is determined that the suppression condition is satisfied.

On the other hand, the main control unit judges whether the received destination code is coincident with any one of exception codes. Any exception code can be stored into a memory for storing exception codes.

When the suppression conditions are satisfied and the destination code is not coincident with any one of the exception codes, the main control unit prohibits the communicator from making a call.

The main control unit judges at a predetermined timing whether cancellation condition has been satisfied. When the cancellation condition is judged to be satisfied, the value of an item to be monitored is reset.

The cancellation condition can also be specified by the main control unit. The cancellation condition can be determined as a condition that a date reaches a predetermined date, or that predetermined specific data is sent when communication is to be made by means of the communicator.

Hereinbelow are explained the function of the information terminal in accordance with the second aspect and the function of the storage medium containing a control program for controlling an operation of the information terminal.

The main control unit determines a fee index which reflects a communication fee of communication made by the communicator. In addition, the main control unit adds the fee indices up to thereby have a total fee index.

On the other hand, the main control unit judges at a predetermined timing whether reset condition is satisfied. When the reset condition is satisfied, the total fee index is reset.

For instance, the reset condition may be determined as a condition that a date reaches a predetermined date, in which case, the main control unit is designed to include a calendar unit or a timer unit.

As an alternative, the reset condition may be determined as a condition that the communicator receives ID data, in which case, the reset condition is designed to include predetermined ID data. The main control unit may be designed to be able to newly determine or change ID data.

The above-mentioned present invention provides the following advantages.

In accordance with the above-mentioned present invention, there is accomplished an information terminal which can suppress a communication fee as well as improves availability.

In addition, the information terminal makes it possible to always accurately display a communication fee without necessity of a user to perform complicated operations.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of the information terminal in accordance with an embodiment of the present invention.

FIG. 2 illustrates an example of a list of telephone numbers.

FIG. 3 illustrates an example of an integration table.

FIG. 4 illustrates an operation of call suppression.

FIG. 5 is a flowchart showing a process for setting an accounting environment.

FIG. 6 is a flowchart showing an operation to be carried out when a call is made.

FIG. 7 is a flowchart showing an operation for clearing call suppression when an integration period newly starts.

FIG. 8 is a flowchart showing an operation for clearing call suppression when an ID number is received.

FIG. 9 illustrates examples of storage mediums in which a program for controlling the information terminal is to be stored.

### DESCRIPTION OF THE PREFERRED EMBODIMENTS

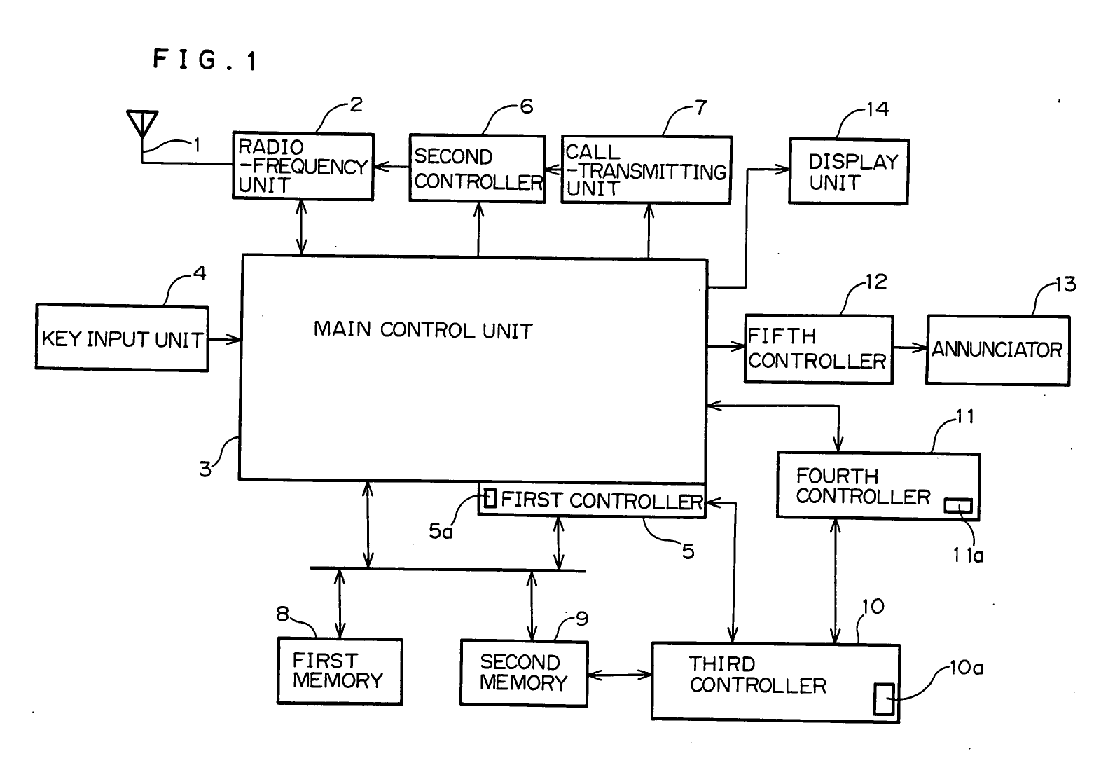

Preferred embodiments in accordance with the present invention will be explained hereinbelow with reference to FIGS. 1 to 8.

As explained later in detail, the information terminal in accordance with the embodiment is characterized in that even when a call is prohibited to be made because a communication fee has exceeded a predetermined upper limit, a call is allowed to be made to a party predetermined as an exception. The information terminal is characterized also in that a total communication fee or a total calling rate having been integrated is automatically reset in accordance with predetermined conditions.

First, a communication system in which the information terminal in accordance with the embodiment is employed is briefly explained hereinbelow.

In the communication system, a base station transmits a signal to the information terminal each time communication amount increases by one rate during communication, which signal is indicating that a calling rate has increased by a degree. The base station further transmits a signal to the information terminal when a call is received by the information terminal, which signal is indicative of a telephone number of a calling party.

Herein, a calling rate indicates a unit based on which communication amount is calculated, and corresponds solely to a communication fee. By calculating the calling rate, it is possible to calculate a communication fee for the communication. A communication fee per a unit of time is reflected to a frequency at which a calling-rate signal is transmitted. In other words, if calling-rate signals are transmitted at a shorter interval, a communication fee becomes higher per a unit of time, whereas if calling-rate signals are transmitted at a longer interval, a communication fee becomes lower per a unit of time.

Hereinbelow is explained the configuration of the information terminal in accordance with the embodiment, with reference to FIG. 1.

The information terminal is comprised of an antenna unit 1, a radio-frequency unit 2, a main control unit 3, a key input unit 4, a first controller 5 for controlling account information, a second controller 6 for controlling transmitting a call, a unit 7 for transmitting a call, a first memory 8 for storing a telephone directory, a second memory 9 for storing account information, a third controller 10 for monitoring account information and controlling transmitting a call, a fourth controller 11 for suppressing a call and clearing suppression of transmitting a call, an annunciator 13, a fifth controller 12 for controlling an operation of the annunciator 13, and a display unit 14.

The first controller 5 includes a third memory 5a, the third controller 10 includes a second memory 10a, and the fourth controller 11 includes a fifth memory 11a.

The antenna unit 1 receives and transmits radio signals.

The radio-frequency unit 2 demodulates received signals and modulates signals to be transmitted from the information terminal. This radio-frequency unit 2 is configured to be controlled by the main control unit 3, and output demodulated signals to the main control unit 3.

A user can input various commands into the information terminal through the key input unit 4. The key input unit 4 is designed to include various operation keys such as numerical keys. The key input unit 4 is configured to output received commands to the main control unit 3.

A user can perform various condition settings through the key input unit 4. In the present embodiment, a user can register numbers into a later mentioned telephone directory list 80, or can set a unit period of time during which a communication fee is to be integrated, suppression conditions, clearing conditions, and the like.

The main control unit 3 controls an operation of the information terminal, and is designed to have various functions such as a function for controlling an interface with peripheral devices, or a function for managing transmitted and received data.

In addition, the main control unit 3 is designed to further include a function of transmitting a signal to the second controller 6 to allow or prohibit the second controller to transmit a call, a function of writing communication time into a later mentioned integration table 90, a function of setting various conditions such as clearing conditions, calling rate limit, or a telephone directory list 80, in accordance with commands input through the key input unit 4, a function of instructing the call-transmitting unit 7 of a telephone number of a party to be called. Furthermore, the main control unit 3 is designed to include a function of acting as a timer, and a calendar function.

The first controller 5 integrates the number of calling rate signals transmitted from a base station during communication. The first controller 5 outputs a result of integration for each communication, that is, a communication fee for each communication, to the second memory 9 to thereby update a later mentioned integration table 90.

The first controller 5 is designed to have a function of converting a calling rate into a communication fee, and vice versa. Data required for such conversion is stored in the third memory 5a equipped in the first controller 5. Herein, the third memory 5a is comprised of a non-volatile memory.

The call-transmitting unit 7 generates a tone signal that corresponds to a telephone number of call destination, instructed from the main control unit 3. The call-transmitting unit 7 outputs the thus generated tone signal to the radio-frequency unit 2 through the second controller 6.

The second controller 6 allows or prohibits transmitting a call in accordance with an instruction transmitted from the main control unit 3. Specifically, when the second controller 6 allows transmission of a call, the second controller 6 outputs a tone signal received from the call-transmitting unit 7 to the radio-frequency unit 2. In contrast, when the second controller 6 prohibits transmitting a call, the second controller 6 does not allow a received tone signal to be transmitted to the radio-frequency unit 2.

The telephone directory memory 8 stores a list 80 of telephone numbers. The telephone directory list 80 stores an attribute of a person, such as a name, and a telephone number of the person in association with each other.

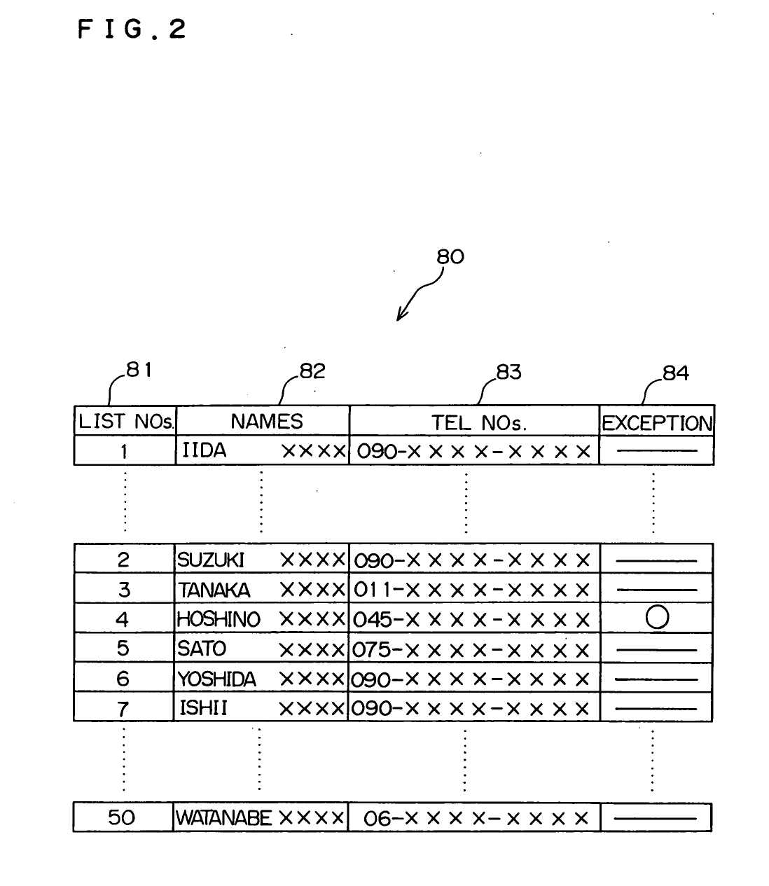

FIG. 2 illustrates an example of the telephone directory list 80 used in the embodiment. As illustrated, the telephone directory list 80 includes a first column 81 of list numbers, a second column 82 of an attribute, a third column 83 of telephone numbers, and a fourth column 84 of exception setting. The first to fourth columns 81, 82, 83 and 84 correspond to one another for each one of parties.

In the first column 81, list numbers are stored. Herein, a list number means an ID code for identifying a combination of a telephone number and an attribute, registered in the telephone directory list 80. A list number is given in accordance with an order of registration. The list number is used also in a later mentioned integration table 90 in order to establish correspondence between the telephone directory list 80 and the integration table 90.

In the second column 82, attribute data relating to parties to be registered in the telephone directory list 80 are stored. Herein, attribute data is comprised of names of the parties, for instance.

In the third column 83, telephone numbers of parties to be registered in the telephone directory list 80 are stored.

In the fourth column 84, there is stored whether exception is set or not. For instance, if exception is set for a certain party, a call to the party is allowed, even if a calling rate in an integration period is over a predetermined upper limit. In the example of the telephone directory list 80 illustrated in FIG. 2, exception is set only for “Hoshino” at the list number 2.

The telephone directory memory 8 is comprised of a rewritable non-volatile memory. A user can display or update what is stored in the telephone directory list 80, if necessary, by inputting a command through the key input unit 4. Among the first to fourth columns 81 to 84 of the telephone directory list 80, a user can register new data in or change the registered data into new ones in the second, third and fourth columns 82, 83 and 84 by way of the main control unit 3 by inputting data through the key input unit 4. On the other hand, a list number in the first column 81 is automatically given by the main control unit 3. In the present embodiment, the main control unit 3 automatically gives 50 list numbers at greatest, that is, 50 persons' data can be registered in the telephone directory list 80.

The second memory 9 stores the integration table 90, and can be accessed from the main control unit 3, the first controller 5 and the third controller 10. The integration table 90 stores a duration of time in which communication is made and a calling rate.

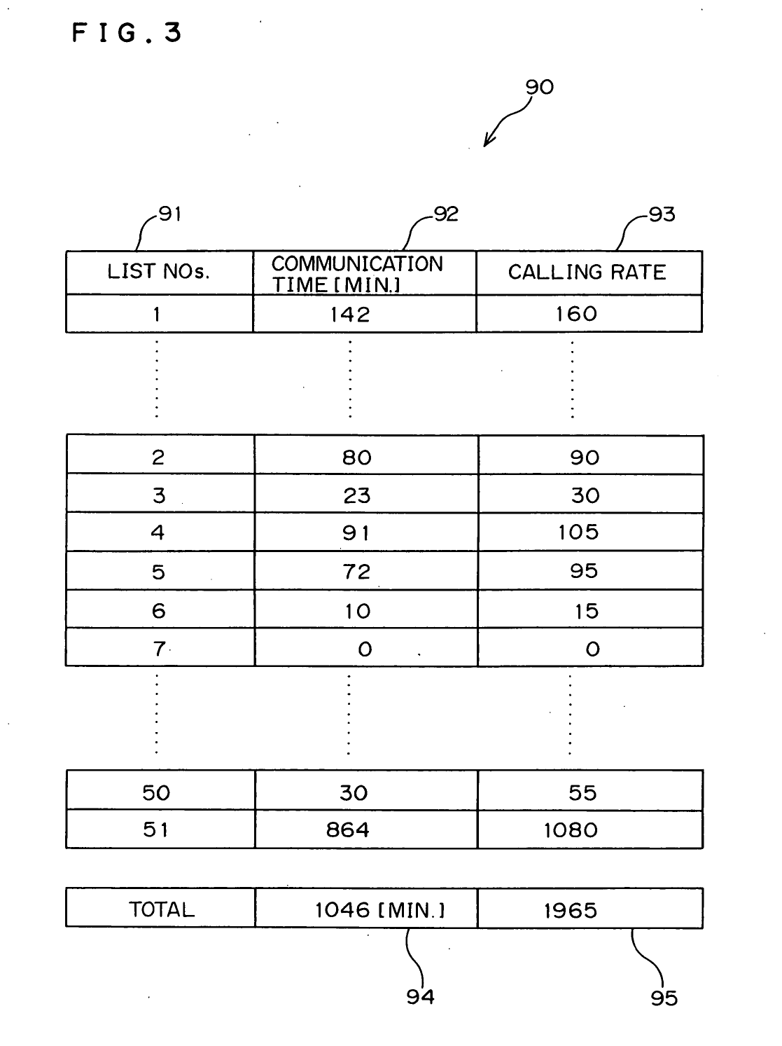

FIG. 3 illustrates an example of the integration table 90. As illustrated, the integration table 90 includes a first column 91 in which a list number is stored, a second column 92 in which communication time is stored, and a third column 93 in which a calling rate is stored. The first to third columns 91 to 93 correspond to one another for each one of communication.

The integration table 90 further includes a fourth column 94 in which a total communication time is indicated and a fifth column 95 in which a total calling rate is indicated. The first column 91 stores list numbers. The list numbers are the same as the list numbers having been explained in the telephone directory list 80. The second column 92 stores integration of communication time in which communication is made with a party identified by a corresponding list number. The third column 93 stores integration of a calling rate at which communication is made with a party identified by a corresponding list number.

The first to third columns 91 to 93 correspond with one another for each one of parties in order to manage a calling rate and communication time for each one of called parties. For example, the communication time of 142 minutes and the calling rate of 160 both stored in the integration table 90 at the list number 1 are associated with “Iida” listed at the list number 1 in the telephone directory list 80.

The first to third columns 91, 92 and 93 are designed to have rows one greater than rows in the telephone directory list 80. For instance, if the telephone directory list 80 had 50 rows in each one of the columns, the integration table 90 has 51 rows in each one of the columns. Communication time and a calling rate for a call that is performed manually by directly entering a telephone number without using the telephone directory list 80 are stored in a row identified by the list number 51.

The fourth column 94 in the integration table 90 stores a total of the communication time listed in rows in the second column 92. The fifth column 95 stores a total of the calling rates listed in rows in the third column 93.

In the present embodiment, it is judged whether a call is allowed or prohibited to be made, based on whether a total calling rate listed in the fifth column 95 has exceeded a predetermined threshold rate.

The integration table 90, in particular, the fifth column 95 is designed to be reset by the third controller 10, when a predetermined clear condition has been satisfied.

The third controller 10 judges whether a total calling rate up to that time has exceeded a predetermined calling rate limit. Herein, a calling rate limit means an upper limit of a calling rate in a communication fee integrated within a unit period. The calling rate limit is stored in the rewritable non-volatile memory 10a equipped in the third controller 10. The calling rate limit can be set or changed by a user by way of the main control unit 3 and the first controller 5 by operating the key input unit 4.

The third controller 10 obtains the total calling rate to be judged, by referring to the column 95 in the integration table 90. In addition, the third controller 10 is designed to have a function for resetting the integration table 90.

The fourth controller 11 judges whether call suppression is to be cleared or not. The fourth controller 11 includes a rewritable non-volatile memory 11a, in which a separately determined clear condition is stored. Herein, a clear condition means a condition for clearing call suppression. For instance, a certain date or a certain number can be determined as the clear condition. In the present embodiment, a starting date of a period of time during which a calling rate is integrated, or an ID number can be determined as the clear condition.

The memory 11a includes a flag which stores whether a call is allowed or prohibited to be transmitted.

The annunciator 13 annunciates a user that the information terminal has just received an incoming call. In the present embodiment, the annunciator 13 is comprised of a buzzer, a light-emitting diode (LED) and/or a vibrator. The fifth controller 12 controls an operation of the annunciator 13 in accordance with an instruction transmitted from the main control unit 3.

The display unit 14 displays various information in accordance with an instruction transmitted from the main control unit 3. In the present embodiment, various conditions can be set by selecting a menu among menus displayed on the display unit 14 or by inputting data, following the displayed messages. For instance, the present embodiment has a menu of “account environment setting”.

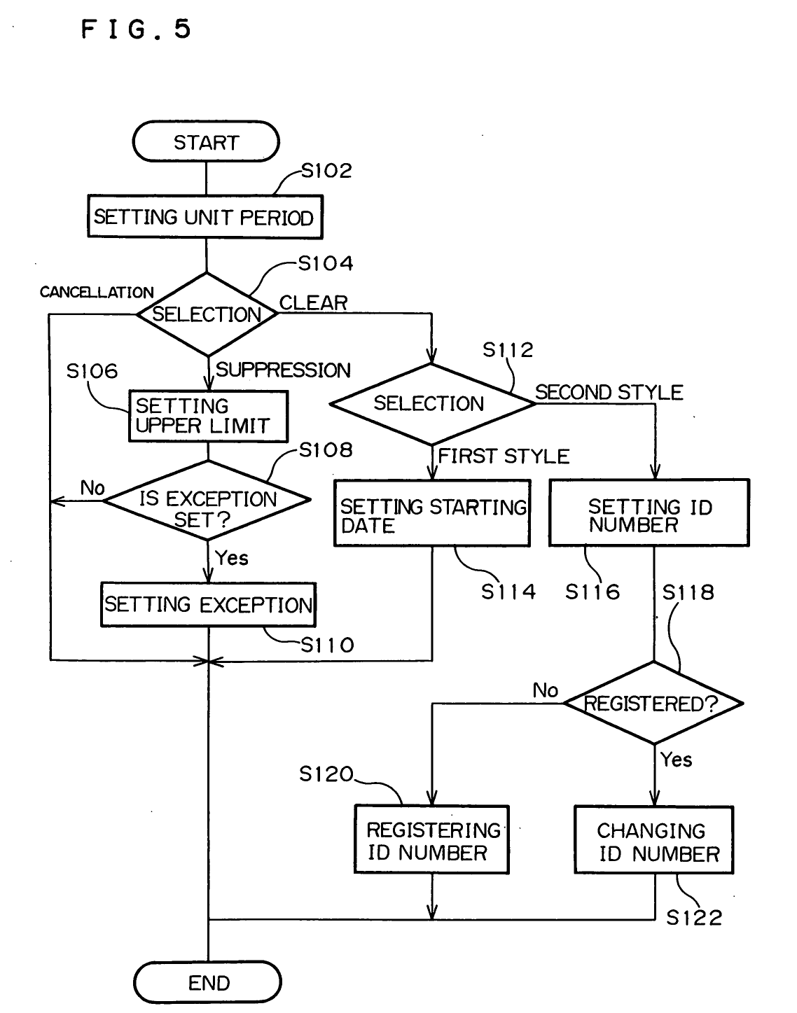

If the menu of “account environment setting” is selected, a later mentioned operation (see FIG. 5) for setting the account environment starts.

The display unit 14 displays what is instructed from the main control unit 3.

The main control unit 3, the first controller 5, the third controller 10, and the fourth controller 11 are designed to include a memory in which specific programs and data are stored, and a processor for accomplishing various functions by executing the programs stored in the memory.

The information terminal is designed to have a connection terminal through which the information terminal is connected to other devices.

The programs stored in the memories can be rewritten by connecting the information terminal to a personal computer, for instance. Accordingly, if a storage medium such as CD-ROM which stores a new control program and a program to rewrite the previous program into the new control program is distributed, a user can always use a latest control program or an optimum control program to thereby operate the information terminal.

Though not illustrated in FIG. 1, the information terminal further includes a speaker, a microphone and the like.

Hereinbelow is explained control and operation of the information terminal in accordance with the embodiment.

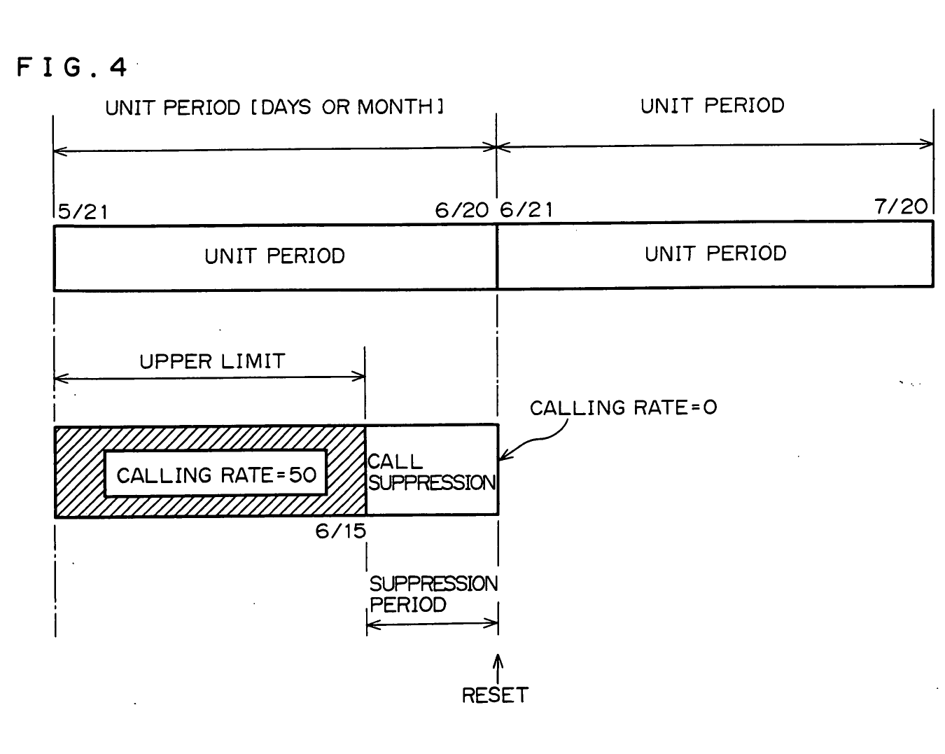

First, call suppression in the information terminal in accordance with the embodiment is explained hereinbelow with reference to FIG. 4.

In an example illustrated in FIG. 4, it is assumed that a unit period starts at 21st in this month, and terminates at 20th in the next month, a calling rate limit is set equal to 50, and call suppression is cleared when a unit period has passed.

With reference to FIG. 4, the integration table 90 is reset on May 21, and calculation of a total calling rate newly starts. After May 21, each time communication is performed, a total calling rate is increased. Then, the total calling rate reaches the calling rate limit on June 15. Accordingly, thereafter, all calls are prohibited except for calls to parties that are set as exceptions in the telephone directory list 80.

On June 21, which is a starting date of a next unit period, the integration table 90 is automatically reset. As a result, call suppression is cleared, and hence, a user can give a call to any party.

Hereinbelow is explained steps to be carried out for setting the account environment.

The process for setting the account environment is started by selecting the menu of “account environment setting” among various menus displayed on the display unit 14. A user can select the menu of “account environment setting” through the key input unit 4.

Hereinbelow is explained the process of “account environment setting” with reference to FIG. 5.

First, a unit period during which a calling rate is integrated is determined in step S102. Specifically, the main control unit 3 causes the display unit 14 to display a request to a user to input data relating to a unit period, specifically, a starting day and a last day. In response to the displayed request, a user inputs his/her desired starting and last days through the key input unit 4.

Then, the main control unit 3 stores the thus input data in the fifth memory 11a equipped in the fourth controller 11. For example, if a user determines that a starting day is 15th and a last day is 14th, a calling rate is integrated for a unit period which starts at the 15th of the current month and ends on the 14th of the next month.

After the unit period has been set in step S102, the main control unit 3 causes the display unit to display a request to a user to select items to be determined thereafter. If a user selects any one of items in response to the request, the main control unit 3 carries out steps for setting the selected item, in step S104. In the embodiment, a user can select any one of items among setting the call suppression condition, setting the clear condition, and cancellation.

If setting the call suppression condition is selected, the main control unit 3 executes steps S106 to step S110. If setting the clear condition is selected, the main control unit 3 executes steps S112 to step S122. If cancellation is selected, the process for setting the account environment ends.

As mentioned above, if setting the call suppression condition is selected in step S194, the main control unit 3 determines an upper limit of in a communication fee, in step S106. This process for setting an upper limit in a communication fee is carried out as follows.

The control unit 3 causes the display unit 14 to display a request to a user to determine an upper limit in a communication fee during a unit period. A user inputs a desired upper limit through the key input unit 4 in response to the displayed request. Then, the main control unit 3 notifies the first controller 5 of the thus input upper limit. The first controller 5 converts the thus input upper limit into a corresponding calling rate, and stores the thus converted calling rate in the fourth memory 10a as a threshold upper limit.

After the step S106 for setting the threshold upper limit is completed, the main control unit 3 asks a user whether exceptions are set in the call suppression, in step S108. The step is carried out as follows.

The main control unit 3 causes the display unit 14 to display a request to a user to determine whether exceptions are set in the call suppression. A user determines whether exceptions are set in the call suppression, in response to the request, by inputting data through the key input unit 4. The main control unit 3 then checks the input data to thereby determine whether exceptions are set in the call suppression.

If the main control unit 3 judges in step S108 that a user does not want to set exceptions in the call suppression, the process for setting the account environment ends.

On the other hand, if the main control unit 3 judges in step S108 that a user wants to set exceptions in the call suppression, step S110 is carried out for starting the process for setting exceptions in call suppression.

In step S110, the main control unit 3 sets call destinations that will be exceptions to call suppression. The call destinations that will be exceptions are selected among parties registered in the telephone directory list 80. Specifically, exceptions are set as follows.

The main control unit 3 displays on the display unit 14 the telephone numbers and attribute data both registered in the telephone directory list 80. A user looks at the display unit 14, and selects a party or parties to be set as exceptions. The main control unit 3 then sets exception in the fourth column 84 in the telephone directory list 80 in accordance with what is selected by a user.

For instance, in the telephone directory list 80 illustrated in FIG. 2 as an example, only “Hoshino” listed at the list number 4 is set as an exception. It is also possible to release a party or parties that had been set as an exception or exceptions up to this time, to thereby make them be objects of call suppression.

After the step S110 is completed, the process for setting the account environment ends.

As mentioned earlier, if setting the clear condition is selected in step S104, steps S112 to step S124 are carried out.

The main control unit 3 displays on the display unit 14 a request to a user to select one of steps for clearing the call suppression. In response to the request, a user selects one of the steps. Then, the main control unit 3 executes a process in accordance with the selected step, in step S112.

In the present embodiment, as the step for clearing the call suppression, a user can select a first type call suppression clearance or a second type call suppression clearance. In the first type call suppression clearance, the call suppression is cleared by resetting the integration table 90 at a starting date of a unit period. In the second type call suppression clearance, the call suppression is cleared by resetting the integration table 90 when a preset ID number is transmitted from a base station together with an incoming call.

If a user selects the first type call suppression clearance in step S112, the main control unit 3 sets a starting date of a unit period as the clear condition, in step S114. As a result, whenever a unit period is switched to a next one, the integration table 90 is always reset. The clear condition is stored in the fifth memory 11a equipped in the fourth controller 11.

Thus, the process for setting the account environment ends.

On the other hand, if a user selects the second type call suppression clearance in step S112, the main control unit 3 carries out an control such that the integration table 90 is reset when the ID number set as the clear condition is transmitted together with an incoming call, in step S116.

Then, the main control unit 3 judges whether the ID number set as the clear condition is already registered in the fifth memory 11a, in step S118.

If the main control unit 3 judges that the ID number is not registered in the fifth memory 11a, the main control unit 3 newly registers an ID number in the fifth memory 11a, in step S120. Specifically, a new ID number is registered as follows.

The main control unit 3 displays on the display unit 14 a message to a user to enter a desired number as an ID number. In response to the message, a user inputs a desired number as an ID number. Then, the main control unit 3 registers the thus input number in the fifth memory 11a as an ID number or the suppression condition.

Thus, the process for setting the account environment ends.

If the main control unit 3 judges that the ID number is already registered in the fifth memory 11a, the main control unit 3 changes the ID number, if necessary, in step S122. Specifically, the ID number is changed as follows.

The main control unit 3 displays on the display unit 14 a message to a user to confirm whether the ID number is to be changed. If a user selects changing the ID number, the main control unit 3 displays on the display unit 14 a message to a user to input a new ID number. In response to the message, a user inputs a new ID number through the key input unit 4. Then, the main control unit 3 registers the thus input number in the fifth memory 11a as a new ID number or new suppression condition.

Thus, the process for setting the account environment ends. When the ID number is not to be changed, the process for setting the account environment ends without carrying out the step of setting a new ID number.

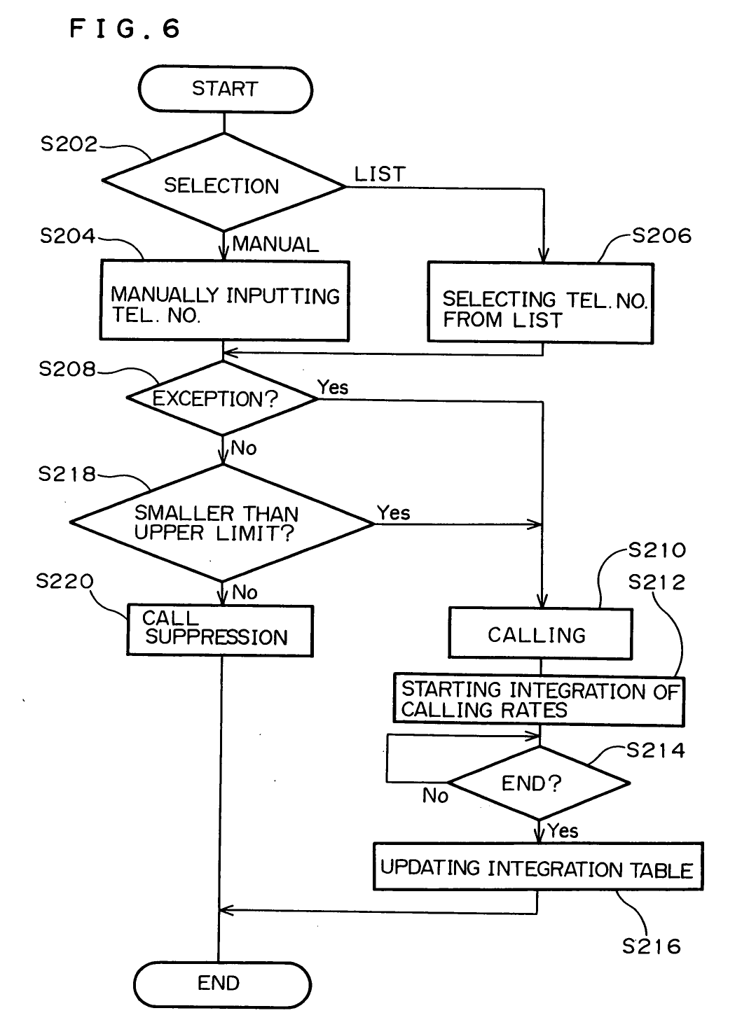

Hereinbelow is explained an operation to be carried out when a call is to be made, with reference to FIG. 6.

The main control unit 3 is normally in a stand-by mode, that is, waits for a command to be input from a user or for an incoming call.

When a user makes a call, a user first selects how a telephone number is designated, by operating the key input unit 4. When a user has selected how a telephone number is designated, the main control unit 3 checks the selection in step S202. In the present embodiment, there are two selections for designating a telephone number. One of them is to select among names or telephone numbers listed in the telephone directory list 80 (hereinbelow, referred to as first selection), and the other is to directly input a telephone number of a party to be called (hereinbelow, referred to as second selection).

If the main control unit 3 confirms that the second selection is selected by a user, the main control unit 3 receives a manually input telephone number in step S204. In detail, the main control unit 3 displays a prompt on the display unit 14 to enter a desired telephone number. When a user enters a telephone number in response to the prompt, the main control unit 3 sets the input telephone number as a call-destination number.

Thereafter, step S208 is carried out.

On the other hand, if the main control unit 3 confirms that the first selection is selected by a user, the main control unit 3 receives a telephone number among telephone numbers listed in the telephone directory list 80, in step S206. In detail, the main control unit 3 displays on the display unit 14 names listed in the second column 82. In response, a user selects one of the displayed names. Then, the main control unit 3 sets the registered telephone number that corresponds to the thus selected name, as a call destination number.

Thereafter, step S208 is carried out.

In step S208, the main control unit 3 judges whether the call-destination number specified in step S204 or S206 is set as an exception to call suppression. In detail, the main control unit 3 judges whether the call-destination number is coincident with any one of the telephone numbers set as exceptions in the telephone directory list 80.

If the main control unit 3 judges in step S208 that the call-destination number specified in step S204 or S206 is set as an exception to call suppression (YES in step S208), step S210 is carried out. In step S210, the main control unit 3 operates all of the components of the information terminal for making a call.

Specifically, the main control unit 3 notifies the second controller 6 of allowance of making a call, and operates the call-transmitting unit 7. Then, the call-transmitting unit 7 generates a tone signal that corresponds to the call-destination number. The second controller 6 transfers the tone signal to the radio-frequency unit 2 without blocking it. The radio-frequency unit 2 modulates the tone signal, and calls a base station by way of the antenna unit 1.

In the example illustrated in FIG. 2, a call is allowed to be made only for “Hoshino” listed at the list number 4 in the telephone directory list 80.

When a line is connected to a called party, the first controller 5 begins integration of a calling rate in step S212. In other words, the first controller 5 starts integrates calling-rate signals transmitted from a base station.

During communication, the main control unit 3 constantly monitors whether a communication has ended in step S214.

If a communication has ended (YES in step S214), the integration table 90 is updated by the first controller 5, based on the result of the integration in step S216.

Similarly, during communication, the main control unit 3 also measures a communication time, and updates the integration table 90, based on the result of measurement. The integration table 90 is updated with respect to not only the second and third columns 92 and 93, but also the fourth and fifth columns 94 and 95.

Then, the process for making a call ends. The main control unit 3 returns to a stand-by mode, that is, waits for a command to be input from a user or for an incoming call.

On the other hand, if the main control unit 3 judges in step S208 that the call-destination number specified in step S204 or S206 is not set as an exception to call suppression (NO in step S208), step S218 is carried out. In step S218, the third controller 10 judges whether a total calling rate has exceeded the calling rate limit. Then, the result is written in the fifth memory 11a equipped in the fourth controller 11.

The total calling rate is obtained by referring to the fifth column 95 in the integration table 90. The main control unit 3 observes the flag of the fifth memory 11a to thereby confirm whether the total calling rate exceeds the calling rate limit, that is, whether a call should be prohibited to be made.

If the total calling rate has not exceeded the calling rate limit (YES in step S218), the above-mentioned steps S210 to S216 are carried out.

On the other hand, if the total calling rate has exceeded the calling rate limit, that is, when a call should be prohibited to be made (NO in step S218), step S220 is carried out. In step S220, the main control unit 3 controls all of the components of the information terminal to suppress making a call. The basic operation in this case is the same as the operation to be carried out in step S210 except that the main control unit 3 notifies the second controller 6 that a call is prohibited to be made. The second controller 6 receiving the notification blocks the tone signal transmitted from the call-transmitting unit 7. As a result, a call is prohibited to be made.

Then, the process for making a call ends. The main control unit 3 returns to a stand-by mode, that is, waits for a command to be input from a user or for an incoming call.

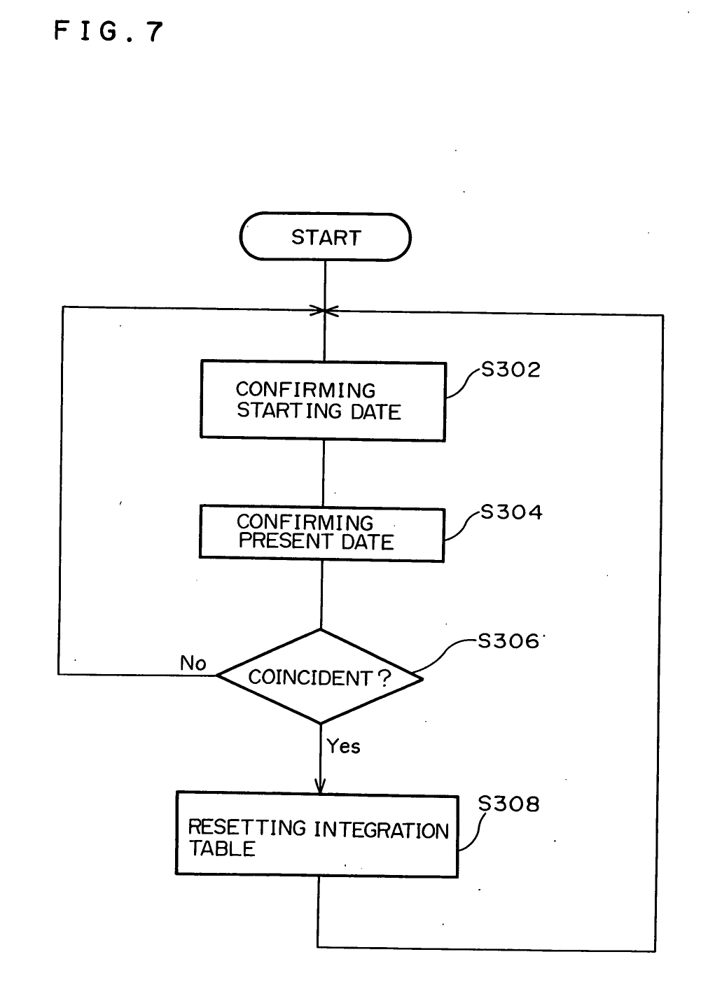

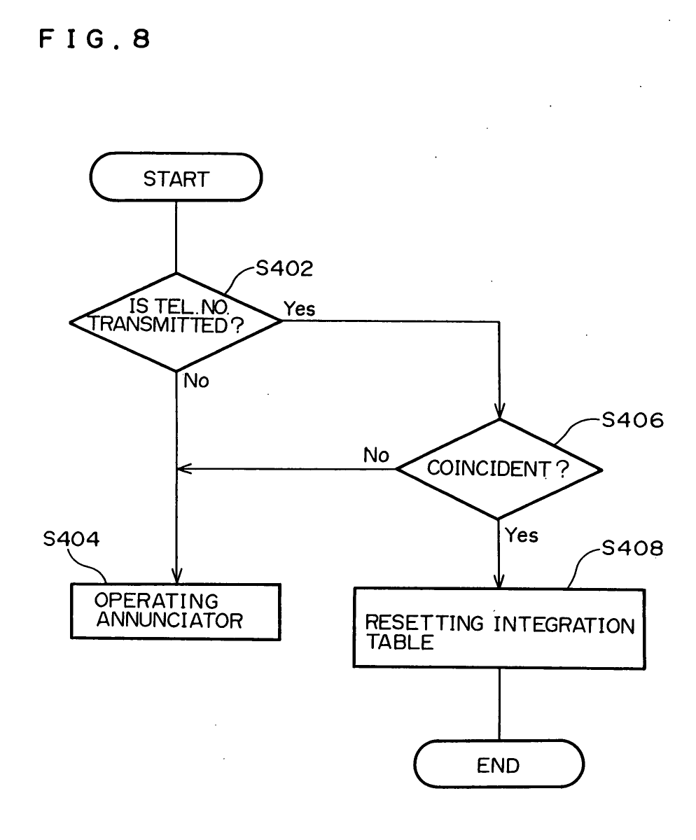

Hereinbelow is explained an operation for clearing call suppression, with reference to FIGS. 7 and 8.

The call suppression is cleared basically by resetting the integration table 90. However, a timing at which the integration table 90 is reset differs depending on which condition is set as the clear condition. Hence, hereinbelow are explained both a case wherein the clear condition is set based on a unit period, specifically, a starting date of a unit period, and a case wherein the clear condition is set based on an ID number. The clear condition has been set in the above-mentioned steps S112 to S122 in FIG. 5.

First, an operation of clearing call suppression is explained with reference to FIG. 7 in the case that the clear condition is set based on a unit period, specifically, a starting date of a unit period.

First, the fourth controller 11 checks the clear condition stored in the fifth memory 11a, in step S302. Herein, the clear condition is set as a starting date of a unit period.

The main control unit 3 uses its internal calendar function to check the date at that time in step S304.

Then, the fourth controller 11 judges whether the date at that time is coincident with a starting date of a unit period having been set as the clear condition, or whether a new unit period starts, in step S306.

If the fourth controller 11 judges that the date at that time is coincident with a starting date of a unit period having been set as the clear condition (YES in step S306), the fourth controller 11 instructs the third controller 10 to reset the integration table 90 in step S308. Thus, the call suppression is cleared.

Thereafter, an outgoing call to any party is allowed to be made until the total calling rate identified in the fifth column 95 exceeds the calling rate limit again.

The steps illustrated in FIG. 7 are executed in a fairly short period after the information terminal is turned on. Accordingly, in step S306, a starting date is never past without the fourth controller 11 judging that the date at that time is coincident with a starting date of a unit period having been set as the clear condition, or that a new unit period starts (YES in step S306).

Then, an operation of clearing call suppression is explained with reference to FIG. 8 in the case that the clear condition is set based on an ID number.

The main control unit 3 is normally in a stand-by mode, that is, waits for a command to be input from a user or for an incoming call. When an incoming call is detected while the main control unit 3 is in a stand-by mode, the main control unit 3 checks whether certain information such as a telephone number of a caller is transmitted together, in step S402.

If such a telephone number is not transmitted together (NO in step S402), the main control unit 3 operates the annunciator 13 to inform a user that an incoming call has been just received, in step S404.

On the other hand, if such a telephone number is transmitted together (YES in step S402), the main control unit 3 informs the fourth controller 11 of the telephone number.

Then, fourth controller 11 judges whether the telephone number is coincident with the ID number stored in the fifth memory 11a as the clear condition, in step S406.

If they are not coincident with each other (NO in step S406), step S404 is carried out, that is, the annunciator 13 is operated.

On the other hand, If they are coincident with each other (YES in step S406), the fourth controller 11 transmits an instruction to the third controller 10 to thereby reset the integration table 90. Thus, the call suppression is cleared.

Thereafter, an outgoing call to any party is allowed to be made until the total calling rate identified in the fifth column 95 exceeds the calling rate limit again.

It should be noted that the steps illustrated in FIG. 8 are carried out only when an incoming call is detected.

Hereinbelow is explained how a communication fee is checked.

A user can instruct the main control unit 3 to display a total communication fee in a unit period, through the key input unit 4. In response to the instruction input by a user, the main control unit 3 causes the first controller 5 to calculate a total communication fee. In detail, the first controller 5 refers to the fifth column 95 in the integration table 90, and obtains that the total calling rate. Then, the first controller 5 calculates a total calculation fee, based on the thus obtained total calling rate and the conversion data stored in the third memory 5a, for example, by multiplying the total calling rate by the conversion data.

Then, the first controller 5 transmits the thus calculated total communication fee to the main control unit 3. The main control unit 3 then displays on the display unit 14 the total communication fee having been calculated by the first controller 5.

As having been explained so far, in accordance with the information terminal, even when a call is prohibited to be made because a total communication fee exceeds the threshold upper limit, it is still possible to make a call to a party or parties that have been set in advance as an exception or exceptions. Thus, it is possible to both suppress rising of a communication fee and to improve convenience. For example, if one's home telephone number is registered as an exception to call suppression, it is always possible to call home.

In addition, a function of the call suppression does not prevent the use of communication fee discount services.

In the information terminal, the total communication fee or the total calling rate is automatically reset in accordance with the predetermined clear condition. Accordingly, it is possible to always display an accurate communication fee without a user having to frequently perform an operation.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

For example, in the embodiment described above, the telephone directory list 80 and the integration table 90 are separately prepared. However, they may be united into one list or table.

In the above-mentioned embodiment, a call is allowed to be made to a party or parties that are in advance set as exception or exceptions, without judging whether the total calling rate has exceeded the calling-rate limit. For example, the judgment may be carried out to a party or parties that are in advance set as exception or exceptions, in which case, a call is allowed to be made to the party or parties regardless of a result of the judgment.

In the embodiment described above, a party or parties to be set as an exception or exceptions to call suppression is(are) designated in the telephone directory list 80. However, a telephone number or attribute data of a party or parties to be set as an exception or exceptions to call suppression may be selected in another way. For instance, a telephone number or attribute data of a party or parties to be set as an exception or exceptions to call suppression may be separately registered in the telephone directory list 80 or in the integration table 90. In such a case, separately registered telephone numbers of parties that are set as exceptions to call suppression would be referenced in step S208 in FIG. 6. A list that correlates names to telephone numbers for each one of parties is not indispensable for setting an exception or exceptions to call suppression.

In the embodiment described above, the calling rate or communication fee was managed in the integration table 90 for each party. However, management of the calling rate or communication fee is not limited to this. The calling rate or communication fee may be managed in any way, unless the total calling rate is calculated.

In the embodiment described above, call suppression was performed based on the total calling rate. As an alternative, call suppression could be performed based on other conditions such as a time factor, in which case, exceptions to call suppression are set in advance in the same way as the embodiment described above.

In the embodiment described above, the calling rate was calculated based on a calling rate signal transmitted from a base station. However, the information terminal may be designed to have data relating to a calling rate, and autonomously calculate a calling rate or an index equivalent to the calling rate, based on the data.

In the embodiment described above, a telephone number treated as an exception is set by a user. However, emergency numbers such as a telephone number of the fire or police department may be initially stored as an exception number in the information terminal.

In the embodiment described above, a program executed by the main control unit 3 is updated by connecting the information terminal to another device and rewriting what is stored in a memory. However, a control program may be updated in other ways. For instance, a storage medium storing a control program and/or data may be exchanged to another storage medium storing a new control program and/or data. In such a case, a program can be updated merely by exchanging a storage medium into a new one. For instance, as an exchangeable storage medium, there may be used a memory card with a semiconductor memory, a compact magnetic storage device, or the like.

In addition, the present invention can be applied regardless of the form of data. For instance, the present invention can be applied to audio and/or image data.

The control of the information terminal having been mentioned so far may be accomplished as a program including various commands, and be presented through a storage medium readable by a computer.

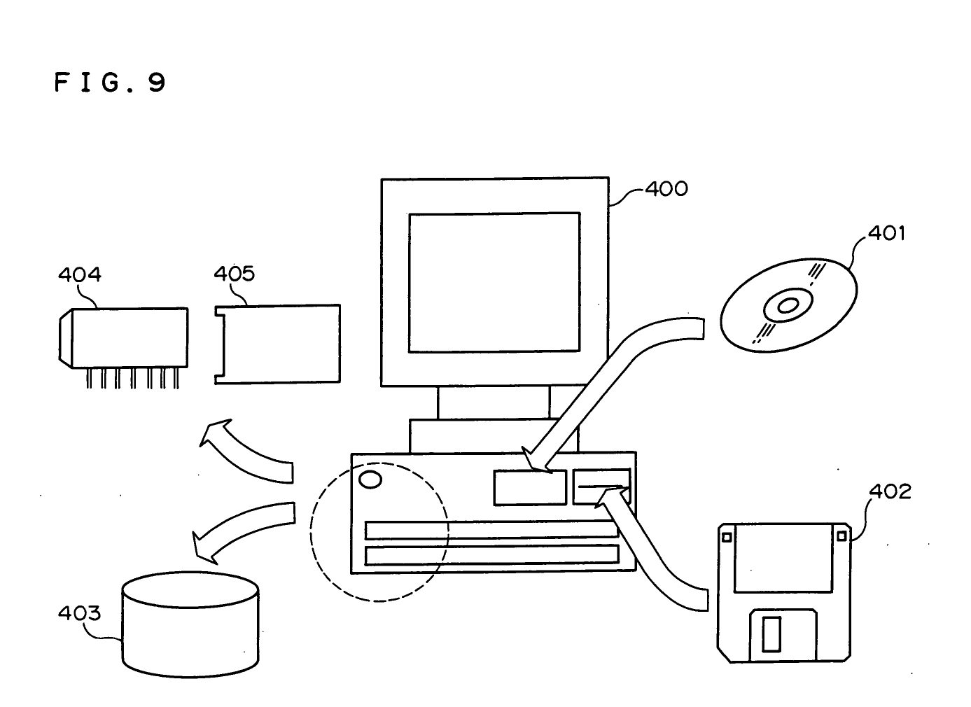

In the specification, the term “storage medium” means any medium which can record data therein. Examples of a storage medium are illustrated in FIG. 9.

The term “storage medium” includes, for instance, a disk-shaped recorder 401 such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk 402, a memory chip 404 such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM 405 such as a compact flush card, a hard disk 403, and any other suitable means for storing a program therein.

A storage medium storing a program for accomplishing the above-mentioned apparatus may be accomplished by programming functions of the above-mentioned apparatuses with a programming language readable by a computer, and recording the program in a storage medium such as mentioned above.

A hard disc equipped in a server may be employed as a storage medium. It is also possible to accomplish the storage medium in accordance with the present invention by storing the above-mentioned computer program in such a storage medium as mentioned above, and reading the computer program by other computers through a network.

As a computer 400, there may be used a personal computer, a desk-top type computer, a note-book type computer, a mobile computer, a lap-top type computer, a pocket computer, a server computer, a client computer, a workstation, a host computer, a commercially available computer, and electronic exchanger, for instance.

The entire disclosure of Japanese Patent Application No. 11-206461 filed on Jul. 21, 1999 including specification, claims, drawings and summary is incorporated herein by reference in its entirety.

1-8. (Canceled)

9. An information terminal having a function of making a call, comprising:
a communicator making communication with a calling or called party; and
a main control unit,
said main control unit calculates a fee index reflecting a fee of communication made by said communicator, integrates said communication fee to thereby calculate a total fee index, judges whether initialization condition is satisfied, and initializes said total fee index if said initialization condition is satisfied.

10. The information terminal as set forth in claim 9, wherein said main control unit includes at least one of a calendar device and a timer, and wherein said initialization condition is that the present date reaches a predetermined date.

11. The information terminal as set forth in claim 9, wherein said main control unit includes predetermined ID data, and wherein said initialization condition is that said communicator receives said ID data.

12. The information terminal as set forth in claim 11, wherein said main control unit has a function of setting or changing said ID data.

13-35. (Canceled)

36. A storage medium readable by a computer, storing a program therein for causing a computer to act as an information terminal having a function of making a call, said information terminal comprising:
a communicator making communication with a calling or called party; and
a main control unit,
said main control unit calculates a fee index reflecting a fee of communication made by said communicator, integrates said communication fee to thereby calculate a total fee index, judges whether initialization condition is satisfied, and initializes said total fee index if said initialization condition is satisfied.

37. The storage medium as set forth in claim 36, wherein said main control unit includes at least one of a calendar device and a timer, and wherein said initialization condition is that the present date reaches a predetermined date.

38. The storage medium as set forth in claim 36, wherein said main control unit includes predetermined ID data, and wherein said initialization condition is that said communicator receives said ID data.

39. The storage medium as set forth in claim 38, wherein said main control unit has a function of setting or changing said ID data.
